(19) United States
(12) Patent Application Publication
(10) Pub. No.: US 2002/0093701 A1
(43) Pub. Date: Jul. 18, 2002

(54) Holographic multifocal lens

(76) Inventors: Xiaoxiao Zhang, Forth Worth, TX (US); Ming Ye, Forth Worth, TX (US); Ruolin Li, Santa Clara, CA (US)

Correspondence Address: THOMAS HOXIE, NOVARTIS CORPORATION, PATENT AND TRADEMARK DEPT, 564 MORRIS AVENUE, SUMMIT, NJ, 079011027

(21) Appl. No.: 10/025,951

(22) Filed: Dec. 19, 2001

Related U.S. Application Data
(60) Provisional application No. 60/258,923, filed on Dec. 29, 2000.

(51) Int. Cl. G03H 1/00; G02B 5/32

(52) U.S. Cl. 359/15; 359/1

(57) ABSTRACT

The invention provides a multifocal optical lens having a holographic optical element that selectively redirects light to provide the wearer with a single image formed from a single focal power. The invention also provides a method for producing a multifocal optical lens having a holographic optical element.

The invention relates to an ophthalmic lens, such as a contact lens. Specifically, the invention relates to an ophthalmic lens that comprises a holographic optical element that allows a wearer to switch between multiple optical powers. The invention also relates to a method for making a multifocal lens.

Historical records document that since at least the early 13 th century people have used the light refracting properties of various transparent materials to improve vision. The earliest eyeglasses were simple convex lenses made of quartz to aid farsightedness. From these early magnifying glasses evolved the specialized glass and plastic eyeglasses and contact lenses commonly used by millions.

The recent advances in polymer chemistry have greatly improved the quality and comfort of both eyeglasses and contact lenses. However, these improvements have primarily benefited those patients who require only single focus corrective lenses. Individuals requiring multifocal vision correction have seen little improvement in the unique problems that they endure.

For example, many individuals who wear bi or tri-focal glasses experience ghost images arising from the near proximity of two lenses with different focal points. The lingering problems associated with current multi-focal vision correction can most clearly be seen in the area of contact lenses.

Several bifocal lens design concepts for ophthalmic lenses, e.g., contact lenses or intraocular lenses, are available. One type of bifocal lens is the diffractive simultaneous vision type. A diffractive simultaneous type lens comprises a diffractive optical element and a refractive optical element. Diffraction is the change in the direction and intensity of light after passing by an obstacle or through an aperture. Refraction is the turning or bending of light when it passes from one medium to another such as from air to water. A diffractive simultaneous type lens splits the light entering the eye into near and far images and projects the images simultaneously on the retina. The presence of dual images on the retina renders neither image completely clear. Furthermore, under low light conditions these lenses create contrast and intensity problems for the user.

Another type of bifocal contact lens is the concentric simultaneous vision type. These types of lenses possess concentric areas of differing focal power. For example, one concentric area provides a focal power for near images while a second concentric area provides a different focal power for far images. The concentric focal areas focus both the near and far images onto a common focal region of the retina thus forming an overlap of images, which blurs both images. For example, when a distant object is viewed through a concentric simultaneous bifocal lens, images of near objects are simultaneously present, veiling or fogging the image of the distant object. Furthermore, because two optical zones share the light entering the concentric simultaneous bifocal lens, contrast and intensity of the focused images are compromised, especially under low light conditions.

Another type of bifocal contact lens is the translating type. The translating type generally follows the design of a conventional bifocal eyeglass lens in that there are two distinct localized sections with different focal powers. To view distant or near objects, the wearer must move the lens on the eye until the proper focal power is reached. The movement of the lens on the eye can present a problem for a wearer because the lens must move a relatively large distance on the eye to change from one focal power to the other. Furthermore, the movement of the lens must be complete before clear vision can be realized.

Other optical lens designs incorporate an active approach to achieve multifocal function. For example, one simultaneous type bifocal lens incorporates thermochromatic coatings to alleviate overlapping of near and far images. In this design a thermochromatic material is applied to the distant optical area of the lens. When the wearer looks down to focus on a near object the thermochromatic material is activated thereby blocking light from entering the distant optical area and preventing the formation of an overlapping distant image. Unfortunately, currently available thermochromatic materials do not activate and deactivate quickly enough for this design to be of practical use.

Another active approach encompasses physically changing the focal length of a lens using micro-circuitry powered by a switchable battery or photocell. This approach is currently not practical because the circuitry and power source necessary to accomplish this task must be small enough to be packaged in a contact lens yet durable enough and reliable enough to withstand the physical forces that are regularly applied to contact lenses, such as taking them in and out to clean them.

More recently, it was discovered that holographic principles might be utilized to produce an active multifocal lens with a high degree of clarity. U.S. Pat. No. 5,997,140 , filed Dec. 29, 1997 which is incorporated herein by reference in its entirety, discusses an optical lens and method of producing an optical lens comprising a combination (i.e. two layered) transmission volume holographic optical element (“HOE”). This lens utilizes a combination hologram to provide a second optical power when the light entering the lens is within a pre-programmed angle range (i.e., the activating angle of the HOE”). The wearer may chose between the optical powers by changing the incident angle of the incoming light. For example, the wearer can change the incident angle of the light by looking down while maintaining the position of the head.

The combination transmission volume holographic lens represents a great improvement over prior multifocal lenses in that this lens forms clearly perceivable images that are focused by one optical power at a time. However, forming an optical lens comprising a multilayer holographic element where that element includes a specific optical power can be a complicated manufacturing task.

Accordingly, a need exists for a multifocal optical lens that allows a user to actively select between at least 2 focusing powers, yet does not require multiple layers of holograms. There also remains a need for a suitable process for producing such a multifocal lens.

An object of the invention is to provide an active multifocal lens.

A further object of the invention is to provide a multifocal lens that does not produce dual axially aligned images.

A further object of the invention is to provide a multifocal lens that may be easily switched from one focal power to another by a wearer.

A further object of the invention is to provide a method for manufacturing an active multifocal lens.

This and other objects and advantages of the present invention are provided by an optical lens comprising at least one holographic optical element and at least one focusing element. The holographic optical element is a hologram characterized by an interference fringe pattern having a finite ray acceptance angle range that diffracts up to 100% of incoming light when the Bragg condition is met. In a preferred embodiment, the holographic optical element possesses substantially neutral focusing power.

Other advantages of the present invention are provided by a method to manufacture an optical lens wherein the method comprises the steps of providing a first source light beam and splitting the first source light beam into first and second light beams. In a preferred embodiment, the light beam is a laser beam and is split by a beam splitter into two approximately equal portions. One of the beams formed by the beam splitter is utilized as a reference beam for recording a hologram. A recordable holographic medium having oppositely located first and second surfaces is provided. The surfaces of the holographic medium may be flat, concave or convex. The first and second light beams are then directed to a surface of the recordable holographic medium wherein the first and second light beams have proper phase relationships to record a volume grating structure within the recordable holographic medium.

The foregoing and other objects, advantages and features of the invention, and the manner in which the same are accomplished will become more readily apparent upon consideration of the following detailed description of the invention taken in conjunction with the accompanying drawings, which illustrate preferred and exemplary embodiments, and wherein:

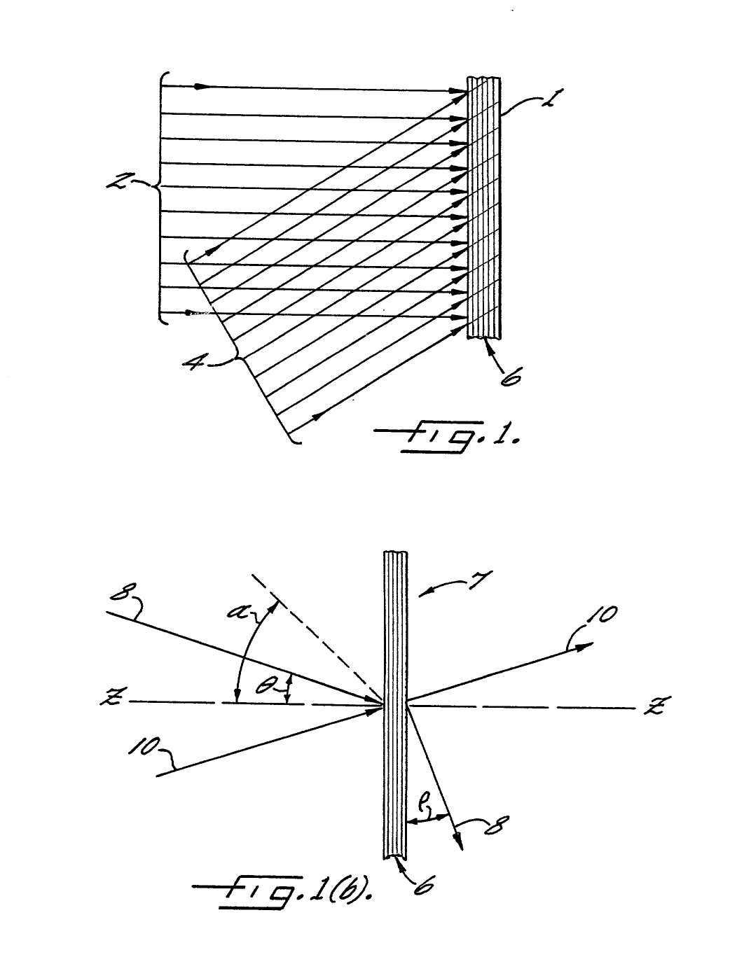

FIG. 1 is a schematic representation of the recording of a transmission interference fringe pattern in a recording medium.

FIG. 1(b) is a schematic representation of the operation of a transmission volume holographic optical element according to the invention.

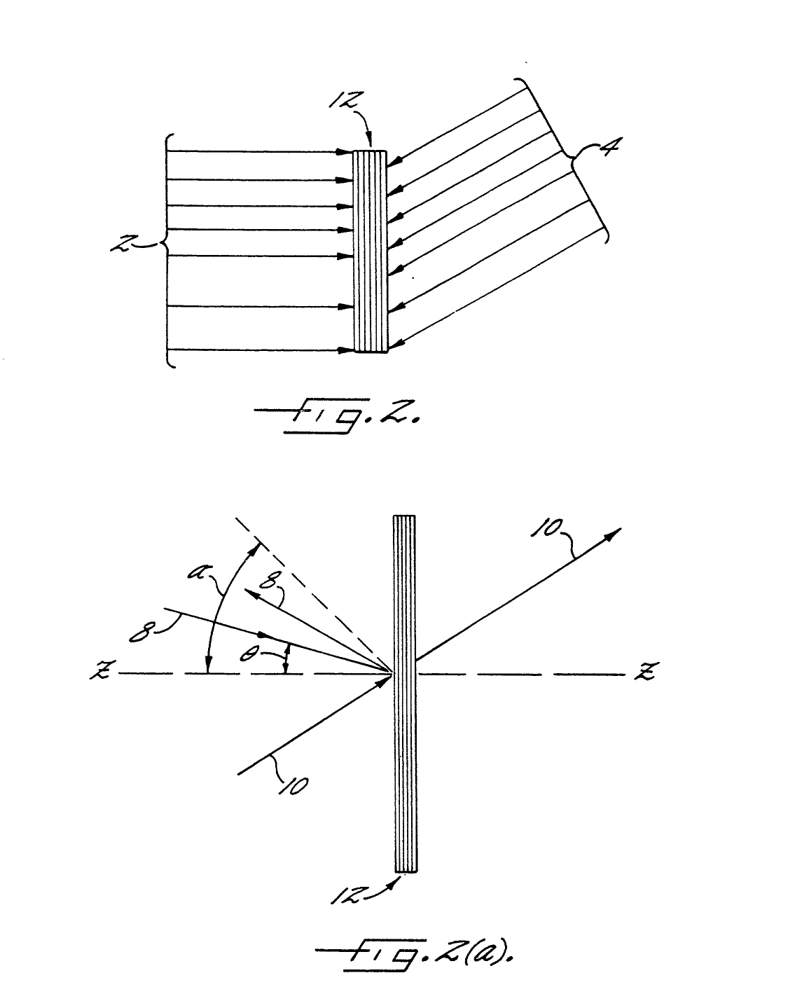

FIG. 2 is a schematic representation of the recording of a reflection interference fringe pattern in a recording medium.

FIG. 2(a) is a schematic representation of the operation of a reflection holographic optical element according to the invention.

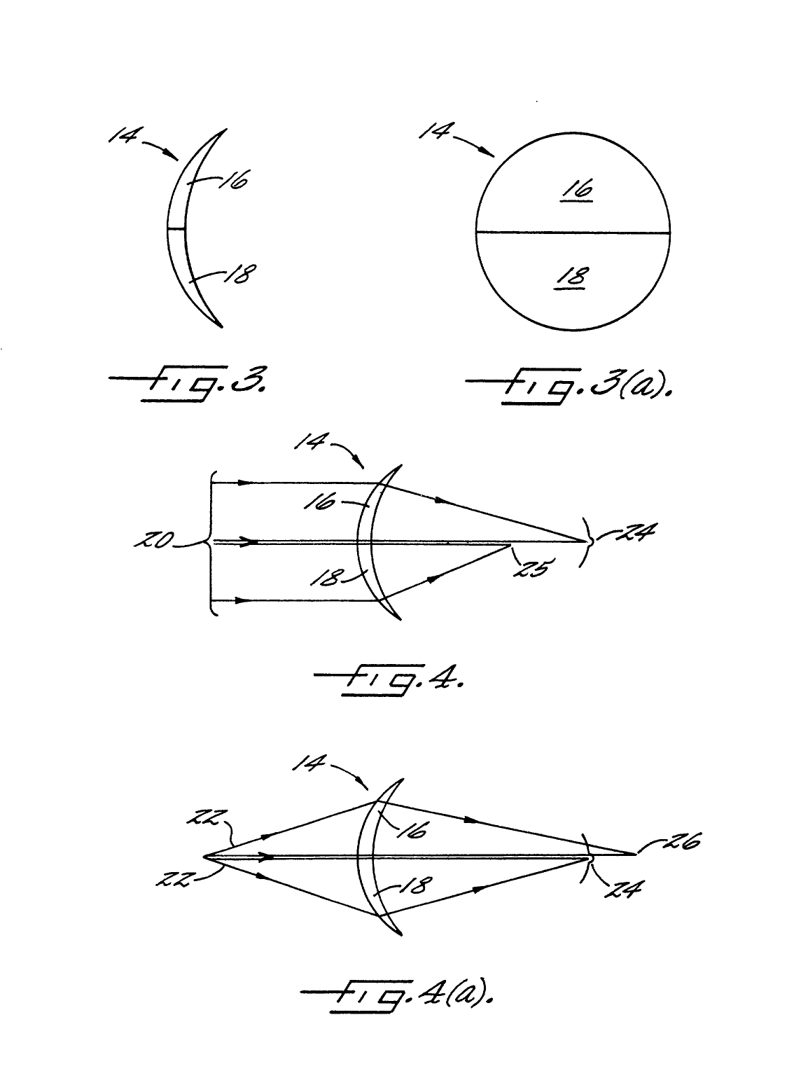

FIG. 3 is a side view of a bifocal lens that may be utilized in the practice of the invention.

FIG. 3(a) is a frontal view of a bifocal lens that may be utilized in the practice of the invention.

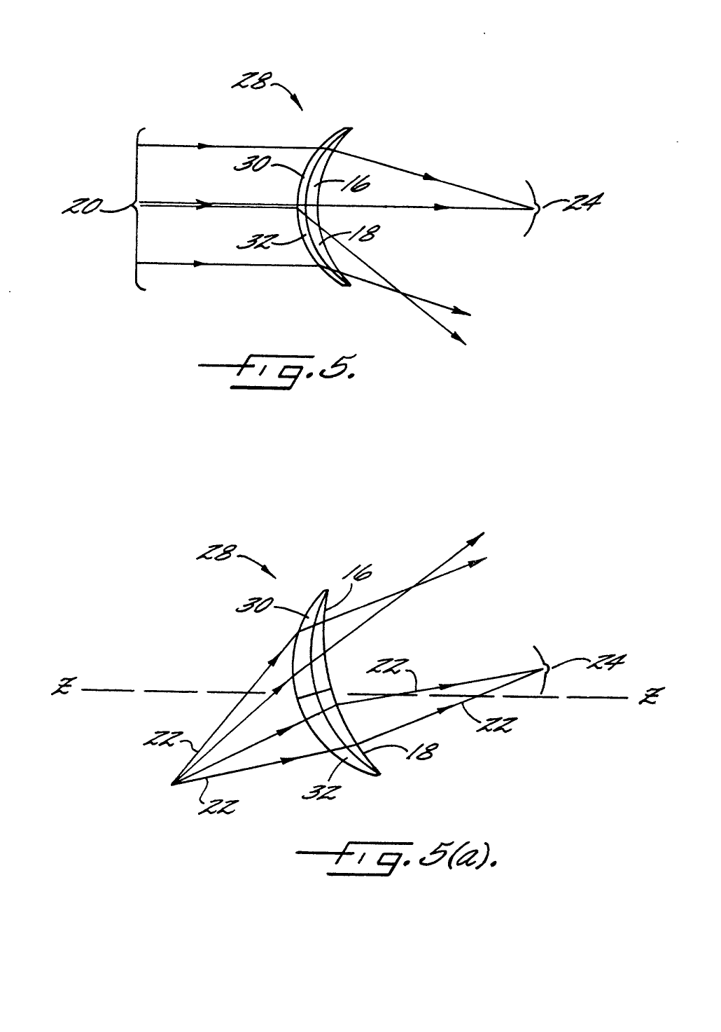

FIG. 4 is a schematic representation of the operation of a bifocal lens as shown in FIG. 3.

FIG. 4(a) is a schematic representation of the operation of a bifocal lens as shown in FIG. 3.

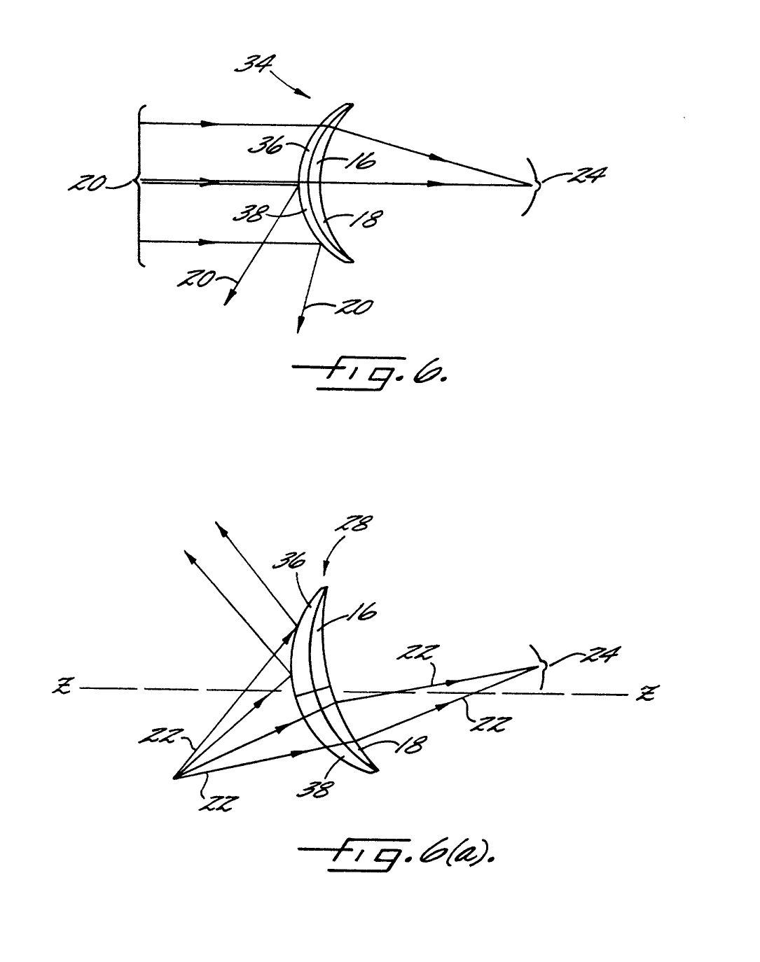

FIG. 5 is a schematic representation of the operation of a multifocal lens according to the invention.

FIG. 5(a) is a schematic representation of the operation of a multifocal lens according to the invention.

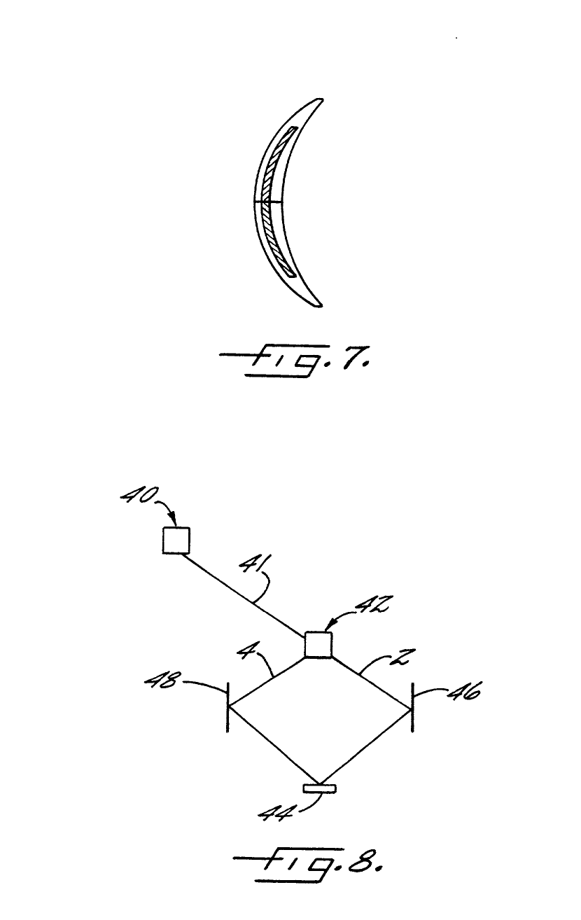

FIG. 6 is a schematic representation of the operation of a multifocal lens according to the invention.

FIG. 6(a) is a schematic representation of the operation of a multifocal lens according to the invention.

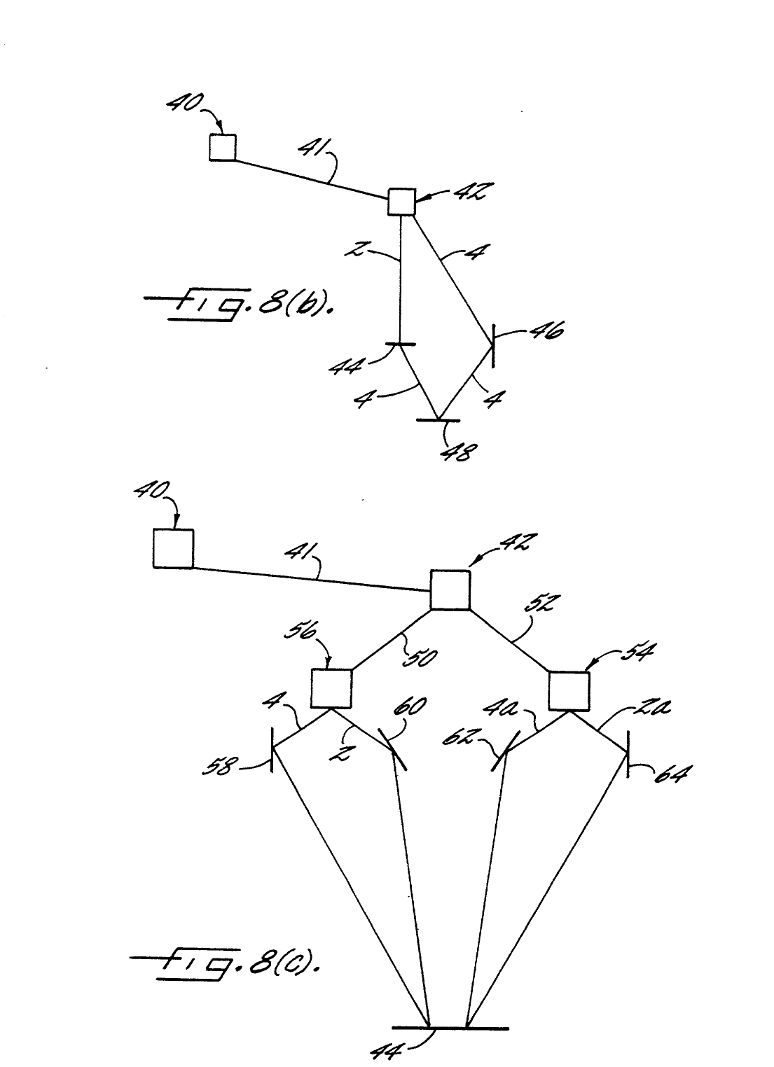

FIG. 7 is a drawing of a further embodiment of the multifocal lens according to the invention.

FIG. 8 is a schematic representation of a method of manufacturing a multifocal lens according to the invention.

FIG. 8(b) is a schematic representation of a method of manufacturing a multifocal lens according to the invention.

FIG. 8(c) is a schematic representation of a method of manufacturing a multifocal lens according to the invention.

The invention provides active multifocal ophthalmic lenses. The invention additionally provides active multifocal lenses for spectacles. The invention also may be utilized in intraocular devices. Hereinafter, the term “optical lenses” is used to indicate both ophthalmic lenses (extra- and intraocular devices) and spectacle lenses, unless otherwise indicated.

The optical lens of the invention provides at least one optical power that may be activated or deactivated (switched on or off) by a user. The switching on and off is accomplished through use of a holographic optical element. Unlike previous holography-based multifocal lenses, however, the holographic optical lens element of the lens according to the invention is not intended to provide focal correction. Instead, the holographic optical lens element according to the invention is designed to either block or redirect light rays that are within its activating angle thus preventing these light rays from focusing on the primary image receptors of the retina.

Generally speaking, holography is a photographic-like process for bending and focusing light and is most commonly known for forming light waves into a three-dimensional image. The formation of three-dimensional objects, however, is a special application of the principles of holography. Holograms exist that do not form three-dimensional objects. The hologram of this invention is such a hologram.

Holography is based upon the wave theory of light. Light is a type of electromagnetic radiation just like radio waves. Like radio waves, light travels in transverse waves that have crests and troughs. A swell or wave in the ocean is a good example of transverse wave motion. The crests and troughs define the wavelength (the distance between crests) of the wave.

Laser light, the type of light that makes holography possible, is a special kind of light. Preferably, the laser light used in holography is “coherent” which means that the light emitted from the laser is of the same wavelength and is in phase. In other words, the light waves that make up the laser beam all have the same distance between their crests and all of the waves rise and fall together.

If two identical laser beams are crossed, the waves of the beams will interfere with one another. For example, a crest of a wave from one beam may meet a crest of a wave from the other beam. This interference has the effect of forming a specific interference fringe pattern that identifies the particular manner in which the laser beams were crossed (i.e. the angles of the beams).

Interference fringe patterns may be recorded. For example, an interference fringe pattern may be recorded by or programmed into a photopolymerizable material. Structures that contain a recorded interference pattern are referred to herein as holographic elements or more specifically as holographic optical elements (“HOE”). The HOEs suitable for the active optical lens of the claimed invention are transmission volume and reflective volume HOEs. The manner of creating transmission volume and reflection volume HOEs are well known to those skilled in the art and will not be repeated herein. However, as an aid to the reader a brief discussion of transmission and reflection HOEs follows.

FIG. 1 is a schematic representation of the recording of an interference fringe pattern in a recording medium (a UV photopolymerizable optical material) 1 to create a transmission volume HOE. The laser beam that is perpendicular to the UV photopolymerizable optical material is referred to as the reference beam 2. The laser beam that intersects the reference beam at an angle is called the object beam 4. Throughout this detailed description, elements such as light rays that are both structurally and functionally equivalent in the various embodiments will be referenced by a single reference numeral. In this example, both the reference beam and the object beam are UV laser beams. The interaction of the light waves from the reference beam 2 and the object beam 4 creates planes of interference known as an interference fringe pattern. The interference fringe pattern created by the UV reference and object beams is recorded into the photopolymerizable optical material and manifests itself as a periodic variation in the refractive index of the optical material. This periodic variation in the refractive index is known as a volume grating structure 6. Since the volume grating structure 6 is a variation in the refractive index of the optical material, the volume grating structure 6 effects the path of light that passes through the HOE 7.

Depending upon the angles of the reference beam and object beam and other variables well known to those skilled in the art of holography, the volume grating structure 6 in the HOE 7 may be programmed to refract only those light waves that enter the optical material within a specified angle. This angle is commonly referred to as the “activating angle” of the volume grating structure and is represented in FIG. 1(b) as angle α. The term activating angle as used herein indicates an incident angle of incoming light, which is defined by the angle formed by the advancing direction of incoming light and the axis normal to the HOE surface, that satisfies the Bragg condition such that the incoming light is diffracted by the interference fringe grating structure of the HOE. The activating angle does not have to be a single value and can be a range of angles. The Bragg condition is well known in the optics art, and it is, for example, defined in Coupled Wave Theory for Thick Hologram Gratings, by H. Kogelnik, The Bell System Technical Journal, Vol. 48, No. 9, p. 2909-2947 (November 1969). The description of the Bragg condition disclosed therein is incorporated by reference. The Bragg condition can be expressed as

cos(φ−Θ)=K/2B

wherein K=2π/Λ, Λ=the grating period of the interference fringes, Θ is the incident angle of incoming light, φ is the slant angle of the grating and B is the average propagation constant, which can be expressed as B=2πn/λ, wherein n is the average refractive index and X is the wavelength of the light. When the Bragg condition is met, up to 100% of incoming light can be coherently diffracted.

FIG. 1(b) schematically describes the operation of the transmission volume HOE 7 of FIG. 1 during “playback” (i.e. when light is directed through the HOE). The z-axis, which is normal to the planar surface of the HOE 7 and the advancing direction of incoming light wave 8 form the incident angle Θ. Incident angle Θ is within the activating angle α. Accordingly, the light wave 8 is diffracted by the pre-programmed volume grating structure 6 of the HOE 7 and exits the HOE 7 at an exiting angle ρ that is different from the incident angle Θ. The other light wave 10 enters the HOE 7 at an angle outside the activating angle. Because this light wave is outside the activating angle, it passes through the HOE 7 unchanged as shown in FIG. 1(b). In this manner, the HOE 7 selectively alters the path of light that passes through it.

Reflection HOEs are similar to transmission HOEs. The most recognizable difference between the two is that reflection HOEs reflect light waves rather than allowing them to pass through. The difference in operation is due to a difference in the manner in which the two HOEs are formed.

FIG. 2 is a schematic representing the recordation of a reflection HOE. In this embodiment, the object beam 4 is adjusted 180° from the orientation of the object beam in FIG. 1. In this example, the resulting volume grating structure 12 is similar to that of the transmission volume HOE in that it has an activating angle α comparable to that of the transmission volume HOE. Referring now to FIG. 2(a), when a light wave 8 having an incident angle Θ within the activating angle α, strikes the HOE, the light wave 8 is reflected by the HOE. As shown in FIG. 2(a), light waves outside the activating angle 10 pass through the HOE undisturbed.

FIG. 3 and FIG. 3(a) are side and front views, respectively, of an exemplary bifocal contact lens 14 utilized by the present invention. The invention is disclosed in reference to a bifocal contact lens for illustration purposes only. The optical lens of the present invention can have more than two optical powers, and encompasses spectacle and intraocular lenses as well. The lens 14 is a contact lens having a first optical element 16 with a first focusing power and a second optical element 18 with a second focusing power. Typically the optical elements are arranged such that the first optical element (or upper optical element) 16 is designed for correction of distant vision while the second optical element (or lower optical element) 18 is designed for correction of near vision. This geometric orientation is typically used because the cornea, upon which the lens rests, basically has a spherical surface. Consequently, when the wearer looks down (as when reading a book) the lens will translate upward slightly so the wearer will predominately be looking through the lower half of the lens.

FIGS. 4 and 4(a) illustrate the corrective nature of the bifocal lens of FIGS. 3 and 3(a). In FIG. 4, light from a distant object 20 is focused by the first optical element 16 to a focal point 24 on the retina, and more specifically at the fovea, the area of the retina with the greatest acuity.

At the same time, the second optical element 18 focuses the light from the distant object at an area 25 in front of the retina. The creation of axially aligned dual images results in neither image being clear to the wearer.

Similarly, FIG. 4(a) illustrates how the bifocal lens of FIG. 3 focuses light received from a near object 22. In this instance, the first optical element 16 (for distance correction) incorrectly focuses the light at a focal point 26 behind the retina while the second optical element 18 correctly focuses an image at the retina. Again, axially aligned images are generated and blurry vision is the result.

In one aspect, the invention encompasses an optical lens comprising at least one transmission or reflection HOE of the type shown in FIG. 1(a) or 2(a) and at least one focusing element such as those shown in FIG. 3. In a preferred embodiment, the HOE is characterized by an interference fringe pattern having a finite ray acceptance angle range that defracts up to 100% of incoming light when the Bragg condition is met. The HOE is further characterized as being a piano lens possessing substantially neutral focusing power. In reality, the HOE will possess some degree of inherent optical power due to its thickness and geometric shape. However, for purposes of this discussion the optical power of the HOE lens is ignored in order to simplify the illustration of the invention since the inherent optical power can be easily factored into the teaching of the present invention.

FIGS. 5 and 5(a) illustrate an embodiment of the invention utilizing a transmission HOE. In FIG. 5, light from a distant object 20 is directed to a bifocal lens 28 comprising a first focusing element 16 and a second focusing element 18. The first focusing element 16 and the second focusing element function as described in relation to FIG. 3. The bifocal lens 28 also comprises a first transmission HOE 30 and a second transmission HOE 32. In FIG. 5 the first transmission HOE 30 is situated adjacent to the outer surface of the first focusing element 16 while the second transmission HOE 32 is situated adjacent the outer surface of the second focusing element 18. The position of the elements could be reversed, however, with the HOE elements adjacent to the inner surface of the focusing elements.

The first transmission HOE 30 is programmed with a volume grating having an activating angle or a range of activating angles which diffract incoming light having the required incident angle. Likewise the second transmission HOE 32 is programmed with a volume grating having an activating angle or a finite range of activating angles which diffracts incoming light having the required incident angle. Preferably the first and second HOEs are programmed with non-overlapping activating angles or ranges of activating angles.

FIG. 5 also illustrates the situation where a wearer of the bifocal lens 28 is viewing a distant object. Light from a distant object 20 strikes the first transmission HOE 30 at an angle that does not activate the first transmission HOE 30. In other words, the light from the distant object 20 forms an incident angle that is outside the activation angle of the first transmission HOE 30. The light from the distant object 20 passes through the first transmission HOE 30 and is focused in accordance with the first focusing element 16, in combination with the optical power of the crystalline lens of the eye (which is not shown), to a focal point 24 on the retina of the eye, more specifically on the fovea. However, the second transmission HOE 32 is programmed with a volume grating structure having an activation angle that diffracts light having the incident angle exhibited by the light from the distant object 20. Therefore, the second transmission HOE 32 diffracts the incoming light, sending it to an area of the retina associated with the far periphery.

FIG. 5(a) illustrates the situation where a wearer is viewing a near object. The second transmission HOE 32 is programmed such that it is not activated by light from the near object 22. In other words, the light from the near object 22 forms an incident angle that is outside the activation angle of the second transmission HOE 32. The light from the near object 22 passes through the second transmission HOE 32 and is focused in accordance with the second focusing element 18, in combination with the optical power of the crystalline lens of the eye (which is not shown), to a focal point 24 on the retina of the eye, more specifically on the fovea. However, the first transmission HOE 30 is programmed with a volume grating structure having an activation angle that diffracts light having the incident angle exhibited by the light from the near object 22. Therefore, the first transmission HOE 30 diffracts the incoming light 22, sending it to an area of the retina associated with the far periphery.

The incident angle of incoming light with respect to the active bifocal lens, more specifically to the HOE portion of the active lens, can be changed by various means. For example, the active lens can be tilted to change the incident angle of the incoming light (i.e. the wearer of the lens can change the incident angle of the light by looking down while maintaining the position of the head). The tilt of the lens shown in FIG. 5(a) in relation to the z-axis illustrates this method of actively switching between the focal powers of the lens. Alternatively, the lens may have a position controlling mechanism that can be actively controlled by the wearer of the lens with one or more muscles of the eye. For example, the lens can be shaped to have a prism ballast such that the movement of the lens can be controlled with the lower eyelid. The activating angle of the lens illustrated in FIG. 5(a) is exaggerated to more easily explain the present invention, and thus, the activating angle of the active lens does not have to be as large as that shown for the tilted lens illustrated in FIG. 5(a). In fact, HOEs suitable for the present invention can be programmed to have a wide range of different activating angles in accordance with the HOE programming methods known in the holographic art. Accordingly, the degree of movement required for the user to switch the HOEs on and off (or stated differently, the degree of movement required to switch from one optical power to another) can be easily changed depending on the design criteria and the needs of each lens wearer.

Although the lens of the present invention provides more than one optical power, the lens does not produce dual axially aligned images. Consequently, the active lens does not produce blurred or fogged images unlike conventional bifocal lenses such as concentric simultaneous bifocal lenses. Instead, the lens of the present invention uses only one optical power at a time to form a clearly perceivable image along the wearer's line of sight, more specifically at the fovea.

The non-blurring advantage of the present lens is a result of the design of the lens that utilizes the inherent anatomy of the eye. It is known that the concentration of the retinal receptors outside the fovea is drastically lower than that in the fovea. Consequently, any image focused substantially outside of the fovea (i.e. to the far periphery) is not clearly perceived since the image is under-sampled by the retina and easily disregarded by the brain of the lens wearer as peripheral vision or images. It has been found that the visual acuity of a human eye drops to about 20/100 for objects only 8° off the line of sight. In the previously described actively controlling manner, the present lens provides clear images from one optical power at a time by utilizing the inherent anatomy of the eye. Utilizing the inherent retinal receptor anatomy of the eye and the ability to program different ranges of activating angles in the HOE lens, the present active lens uniquely and selectively provides clear images of objects that are located at different distances. In contrast to translating bifocal lenses, the active lens can be easily designed to require only a small movement of the lens to selectively provide images from different distances.

In another embodiment, the invention utilizes a reflection HOE. In FIG. 6, light from a distant object 20 is directed to a bifocal lens 34 comprising a first focusing element 16 and a second focusing element 18. The first focusing element and the second focusing element provide the same function as described in relation to the transmission HOE embodiment of the invention. The bifocal lens 34 also comprises a first reflection HOE 36 and a second reflection HOE 38. In FIG. 6 the first reflection HOE 36 is situated adjacent to the outer surface of the first focusing element 16 while the second reflection HOE 38 is situated adjacent the outer surface of the second focusing element 18. The position of the elements could be reversed, however, with the HOE elements adjacent to the inner surface of the focusing elements.

The first reflection HOE 36 is programmed with a volume grating having an activating angle or a range of activating angles which reflects incoming light having the required incident angle. Likewise the second reflection HOE 38 is programmed with a volume grating having an activating angle or a finite range of activating angles which reflects incoming light having the required incident angle. Preferably the first and second HOEs are programmed with non-overlapping activating angles or ranges of activating angles.

FIG. 6 also illustrates the situation where a wearer of the bifocal lens 34 is viewing a distant object. Light from a distant object 20 strikes the first reflection HOE 36 at an angle that does not activate the first reflection HOE 38. In other words, the light from the distant object 20 forms an incident angle that is outside the activation angle of the first reflection HOE 36. The light from the distant object 20 passes through the first reflection HOE 36 and is focused in accordance with the first focusing element 16, in combination with the optical power of the crystalline lens of the eye (which is not shown), to a focal point 24 on the retina of the eye, more specifically on the fovea. However, the second reflection HOE 38 is programmed with a volume grating structure having an activation angle that reflects light having the incident angle exhibited by the light from the distant object 20. Therefore, the second reflection HOE 38 reflects the incoming light, preventing it from entering the eye.

FIG. 6(a) illustrates the situation where a wearer is viewing a near object. Light from the near object 22 strikes the second reflection HOE 38 at an angle that does not activate the second reflection HOE 38. In other words, the light from the near object 22 forms an incident angle that is outside the activation angle of the second reflection HOE 38. The light from the near object 22 passes through the second reflection HOE 38 and is focused in accordance with the second focusing element 18, in combination with the optical power of the crystalline lens of the eye (which is not shown), to a focal point 24 on the retina of the eye, more specifically on the fovea. However, the first reflection HOE 36 is programmed with a volume grating structure having an activation angle that reflects light having the incident angle exhibited by the light from the near object 22. Therefore, the first reflection HOE 30 reflects the incoming light, preventing it from entering the eye.

In both the transmission and reflection embodiments, a portion of the available light is removed from the fovea. However, this loss of light has a negligible effect, if any, on the vision of the user because the pupil will quickly enlarge to compensate the light loss to the fovea. Accordingly, the light intensity reaching the fovea will be constant in practice.

HOEs suitable for the present invention can be produced, for example, from a polymerizable or crosslinkable optical material, especially a fluid optical material. The term “fluid” as used herein indicates that a material is capable of flowing like a liquid. Hereinafter and for illustration purposes only, the term polymerizable material is used to indicate both polymerizable and crosslinkable materials, unless otherwise indicated.

Preferably, the polymerizable material used as the recording medium to create the HOE is a biocompatible material. The term biocompatible material as used herein refers to a polymeric material that does not deteriorate appreciably and does not induce a significant immune response or deleterious tissue reaction (e.g., toxic reaction or significant irritation) over time when implanted into or placed adjacent to the biological tissue of a subject. Exemplary biocompatible materials that can be used to produce a HOE suitable for the present invention are discussed in U.S. Pat. No. 5,508,317 to Beat Müller (“Müller '317) and International Patent Application No. PCT/EP96/00246 to Mühlebach, which patent and patent application are herein incorporated by reference and further discussed below. Suitable biocompatible optical materials are highly photocrosslinkable or photopolymerizable optical materials, which include derivatives and co-polymers of a polyvinyl alcohol, polyethyleneimine, or polyvinylamine.

In accordance with the present invention, suitable HOE recording mediums are polymerizable and crosslinkable optical materials that can be relatively rapidly photopolymerized or photocrosslinked. Periodic variations in the refractive index can be created within a rapidly polymerizable optical material. In this manner, a volume grating structure can be formed while the optical material is being polymerized to form a solid optical element. An exemplary group of rapidly polymerizing optical materials suitable for the present invention is disclosed in Müller '317. A preferred group of rapidly polymerizing optical materials, as described in Müller '317, are those that have a 1,3-diol basic structure in which a certain percentage of the 1,3-diol units have been modified to a 1,3-dioxane having in the 2-position a radical that is polymerizable but not polymerized. The polymerizable optical material is preferably a derivative of a polyvinyl alcohol having a weight average molecular weight, M_{w}, of at least about 2,000 that, based on the number of hydroxy groups of the polyvinyl alcohol, comprises from about 0.5% to about 80% of units of formula I:

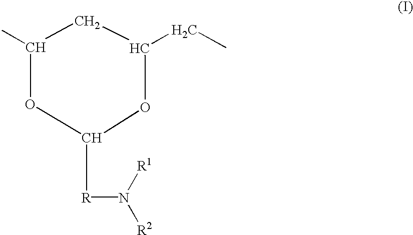

wherein

R is lower alkylene having up to 8 carbon atoms,

R¹ is hydrogen or lower alkyl and

R² is an olefinically unsaturated, electron-attracting, copolymerizable radical prefer ably having up to 25 carbon atoms. R² is, for example, an olefinically unsaturated acyl radical of formula R³—CO—, in which

R³ is an olefinically unsaturated copolymerizable radical having from 2 to 24 carbon atoms, preferably from 2 to 8 carbon atoms, especially preferably from 2 to 4 carbon atoms.

In another embodiment, the radical R² is a radical of formula II

—CO—NH—(R⁴—NH—CO—O)_{q}—R⁵—O—CO—R³ (II)

wherein

q is zero or one;

R⁴ and R⁵ are each independently lower alkylene having from 2 to 8 carbon atoms, arylene having from 6 to 12 carbon atoms, a saturated divalent cycloaliphatic group having from 6 to 10 carbon atoms, arylenealkylene or alkylenearylene having from 7 to 14 carbon atoms, or arylenealkylenearylene having from 13 to 16 carbon atoms; and

R³ is as defined above.

Lower alkylene R preferably has up to 8 carbon atoms and may be straight-chained or branched. Suitable examples include octylene, hexylene, pentylene, butylene, propylene, ethylene, methylene, 2-propylene, 2-butylene and 3-pentylene. Preferably, lower alkylene R has up to 6 and more preferably up to 4 carbon atoms. Methylene and butylene are especially preferred. R¹ is preferably hydrogen or lower alkyl having up to seven, especially up to four, carbon atoms. Hydrogen is an especially preferred embodiment of R^{1.}

As for R⁴ and R⁵, lower alkylene R⁴ or R⁵ preferably has from 2 to 6 carbon atoms and is preferably straight-chained. Suitable examples include propylene, butylene, hexylene, dimethylethylene and, especially prefer ably, ethylene. Arylene R⁴ and R⁵ is preferably phenylene that is unsubstituted or is substituted by lower alkyl or lower alkoxy, especially 1,3-phenylene or 1,4-phenylene or methyl-1,4-phenylene. A saturated divalent cycloaliphatic group R⁴ or R⁵ is preferably cyclohexylene or cyclohexylene lower alkylene, for example cyclohexylenemethylene, that is unsubstituted or is substituted by one or more methyl groups, such as, for example, trimethylcyclohexylenemethylene or the divalent isophorone radical. The arylene unit of alkylenearylene or arylenealkylene R⁴ or R⁵ is preferably phenylene, unsubstituted or substituted by lower alkyl or lower alkoxy, and the alkylene unit thereof is preferably lower alkylene, such as methylene or ethylene, especially methylene. Such radicals R⁴ or R⁵ are therefore preferably phenylenemethylene or methylenephenylene. Arylenealkylenearylene R⁴ or R⁵ is preferably phenylene-lower alkylene-phenylene having up to 4 carbon atoms in the alkylene unit, for example phenyleneethylenephenylene. The radicals R⁴ and R⁵ are each independently preferably lower alkylene having from 2 to 6 carbon atoms, phenylene, unsubstituted or substituted by lower alkylene having from 2 to 6 carbon atoms, phenylene, unsubstituted or substituted by lower alkyl, cyclohexylene or cyclohexylene-lower alkylene, unsubstituted or substituted by lower alkyl, phenylene-lower alkylene, lower alkylene-phenylene or phenylene-lower alkylene-phenylene.

Another group of exemplary polymerizable optical materials suitable for the present invention is disclosed in International Patent Application No. PCT/EP96/00246 to Mühlebach. Suitable optical materials disclosed therein include derivatives of a polyvinyl alcohol, polyethyleneimine or polyvinylamine which contains from about 0.5 to about 80%, based on the number of hydroxyl groups in the polyvinyl alcohol or the number of imine or amine groups in the polyethyleneimine or polyvinylamine, respectively, of units of the formula IV and V:

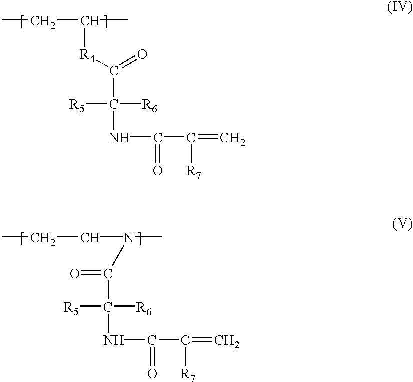

wherein R₅ and R₆ are, independently of one another, hydrogen, a C₁-C₈ alkyl group, and aryl group, or a cyclohexyl group, wherein these groups are unsubstitued or substituted; R₇ is hydrogen or a C₁-C₈ alkyl group, preferably is methyl; and R₄ is an —O— or —NH— bridge, preferably —O—. Polyvinyl alcohols, polyethyleneimines and polyvinylamines suitable for the present invention have a number average molecular weight between about 2000 and 1,000,000, preferably between 10,000 and 300,000, more preferably between 10,000 and 100,000, and most preferably 10,000 and 50,000. A particularly suitable polymerizable optical material is a water-soluable derivative of a polyvinyl alcohol having between about 0.5 to about 80%, preferably between about 1 and 25%, more preferably between about 1.5 and about 12%, based on the number of hydroxyl groups in the polyvinyl alcohol, of the formula IV that has methyl groups for R₅ and R₆, hydrogen for R₇, —O— (i.e. an ester link) for R₄.

Another group of HOEs suitable for the present invention can be produced from conventional volume holographic optical element recording media. As with the above-described polymerizable materials for HOEs, object light and collimated reference light are simultaneously projected onto an HOE recording medium such that the electromagnetic waves of the object and reference light from interference fringe patterns. The interference fringe patterns, i.e., volume grating structure, are recorded in the HOE medium. When the HOE recording medium is fully exposed, the recorded HOE medium is developed in accordance with a known HOE developing method. Suitable volume holographic optical element recording media include commercially available holographic photography recording materials or plates, such as dichromatic gelatins. Holographic photography recording materials are available from various manufacturers, including Polaroid Corp. When photographic recording materials are used as the HOE, however, toxicological effects of the materials on the ocular environment must be considered. Accordingly, when a conventional photographic HOE material is used, it is preferred that the HOE is encapsulated in a biocompatible optical material (see FIG. 7). Useful biocompatible optical materials for encapsulating the HOE include optical materials that are suitable for the first focusing element of the present lens.

The multifocal lens of the present invention can be produced from separately produced HOEs and focusing elements. The HOEs are fabricated and then permanently joined, adhesively or thermally, to the focusing element to form a coherent contact lens. The focusing elements can be fabricated using techniques well known to those skilled in the art of making contact lenses. The HOEs can be fabricated using the techniques described previously and further discussed below.

An exemplary process for producing a transmission HOE of the present invention is illustrated in FIG. 8. A light source 40, preferably a laser light source and most preferably a UV laser light source, is provided which produces a light beam 41. Although the suitable wavelength of the light source depends on the type of HOE employed, preferred wavelength ranges are between 300 nm and 600 nm.

The light source light beam 41 is directed to a beam splitter 42. The beam splitter 42 splits the light source light beam 41 into two portions, preferably two equal portions. Two mirrors 46 and 48 are placed on opposite sides of the beam splitter 42 such that one split portion 2 of the light source light beam 41 continues on its original path and is directed to the first mirror 46 and the second portion 4 is directed to the second mirror 48. The first portion 2 of the light beam is the reference beam and the second portion 4 is an object beam. Typically power levels for beams utilized in the practice of the invention are on the order of 1 to 10 mW/cm² per beam. Those skilled in the art will recognize that the function and designation of the light portions could be reversed. Similarly, the power of the beams and the angle separating the beams may be adjusted as necessary depending upon the particular situation.

A holographic recording medium of the kind previously discussed is provided in recording medium holder 44. For purposes of illustration, the recording medium is assumed to be of the fluid type and forms non-fluid optical material when exposed to light. The recording medium holder 44 is preferably substantially transparent to light and more preferably transparent to UV light. In the contact lens context the recording medium holder 44 will be a typical contact lens mold. A typical lens mold is produced from a transparent or UV transmissible thermoplastic and has two mold halves, i.e., one mold half having the first surface of the lens and the other mold half having the second surface of the lens. The mold can form the holographic recording medium into a flat, concave or convex structure.

The two mirrors, 46 and 48, direct the reference light beam 2 and the object light beam 4 to enter the holographic recording medium in proper phase to record a volume grating structure from one surface of the holographic recording medium. Optionally, after the volume grating structure is recorded and the HOE formed, the light set up used for the recording is turned off and the HOE is subjected to a post-curing step to ensure that all of the fluid optical material in the mold is fully polymerized. For example, a UV light source may be used to post-cure the HOE. If needed, a UV light source may also be utilized to partially cure the optical material prior to recording the volume grating structure. Once again, the particular situation will dictate the exact parameters (e.g., light power) for each step. After the HOE is formed it may be attached to an appropriate focusing element. Changing the positions and angles of the mirrors and beam splitters in the arrangement can produce a large variety of HOEs having different activating angles.

Similarly, beam splitters and mirrors may be used to create a reflection HOE. Referring now to FIG. 8(b). A light source 40 directs a light source beam 41 to a beam splitter 42. The beam splitter 42 splits the light source beam 41 into two portions, preferably two equal portions. One beam, the reference beam 2 is directed to one face of the recording medium holder 44. Two mirrors 48 and 46 direct the object beam 4 to the other face of the recording medium holder 44. The recording medium is then polymerized in the same manner as the transmission HOE. Additionally, those skilled in the art will recognize that the previously discussed methods of manufacture may be utilized with little modification to form spectacle lenses.

The combination of light beams, beam splitters and mirrors may be combined in any number of ways to create any number of HOEs. An example of such a combination used to simultaneously create two HOEs is schematically illustrated in FIG. 8(c).

A light source 40, preferably a laser light source and most preferably a UV laser light source, is provided which produces a light beam 41. The light source light beam 41 is directed to a beam splitter 42. The beam splitter 42 splits the light source light beam 41 into two portions, preferably two equal portions 50 and 52. The first portion 50 is directed to a second beam splitter 56 and the second portion is directed to a third beam splitter 54. The second and third beam splitters in turn split the first and second portions of the initial light beam into first and second portions to create 4 light beams—two sets of reference and object beams: 2 and 4 and 2a and 4a.

Two sets of mirrors direct the two sets of reference and object beams to a recording medium holder 44. The first set of reference 2 and object 4 beams are directed to a first portion of a recording medium holder 44 by two mirrors 58 and 60. The second set of reference 2a and object 4a beams are directed to a second portion of a recording medium holder 44 by two mirrors 62 and 64. The recording medium is then polymerized and a volume grating structure created within the medium in the same manner as discussed previously.

Alternatively, the lens of the present invention can be produced by recording a HOE or multiple HOEs in a multifocal lens. In this embodiment the volume grating structure is recorded directly into the multifocal lens. The recording process is essentially the same as that described above. However, when determining the focusing power of the lens consideration must be given to the volume of the lens devoted to the hologram. Similarly, an effective amount of a light absorbing compound (e.g., a UV absorber when UV laser light is used) may be added to the recording medium in the mold such that the light beams entering from one side do not have a strong polymerizing influence on the optical material that is located closer to the second side of the mold. The addition of the light absorber ensures that a distinct layer of a HOE is formed. The effective amount of a light absorber varies depending on the efficacy of the light absorber, and the amount of the light absorber should not be so high as to significantly interfere with proper polymerization of the optical material. Although preferred light absorbers are biocompatible light absorbers, especially when the present invention is used to produce ophthalmic lenses, non-biocompatible light absorbers can be used. When a non-biocompatible light absorber is used, the resulting HOE can be extracted to remove the light absorber after the HOE is fully formed.

Exemplary UV absorbers suitable for the optical materials include derivatives of o-hydroxybenzophenone, o-hyroxyphenyl salicylates and 2-(o-hydroxyphenyl) benzotriazoles, benzenesulfonic acid and hindered amine. Particularly suitable UV absorbers include topically acceptable UV absorbers, e.g., 2,4-dihydroxybenzophenone, 2,2′-dihydroxy-4,4-dimethoxybenzophenone, 2-hydroxy-4-methoxybenzophenone and the like. An exemplary embodiment uses between 0.05 and 0.2 wt % of a UV absorber, preferably a benzenesulfonic acid derivative, e.g., benzenesulfonic acid, 2,2-([1,1′-biphenyl]-4,4-diyldi-2,1-ethenediyl) bis-disodium salt.

As another embodiment of the present invention, the combination HOE can be produced by a sequential recording method. A closed mold assembly, which has a pair of two mold halves, containing a fluid polymerizable or crosslinkable optical material is subjected to a volume grating structure recording process, and then the mold assembly is opened while leaving the formed HOE layer adhered to the optical surface of one mold half. An additional amount of the polymerizable optical material or a chemically compatible second polymerizable optical material is placed over the first HOE layer. Then, a new pairing mold half, which has a larger cavity volume than the previously removed mold half, is mated with the mold half that has the first HOE layer. The new mold assembly is subjected to a second polymerizing process to form a focusing element layer over the HOE element. The resulting lens is a combination lens having two sequentially formed and adjoined focusing and HOE layers.

In accordance with the present invention, HOEs of the present invention preferably have a diffraction efficiency of at least about 70%, more preferably at least about 80%, most preferably at least 95%, over all or substantially all wavelengths within the visible spectrum of light. Especially suitable HOEs for the present invention have a diffraction efficiency of 100% over all wavelengths of the spectrum of visible light. However, HOEs having a lower diffraction efficiency than specified above can also be utilized for the present invention. Additionally, preferred HOEs for the present invention have a sharp transition angle between the activated and non-activated stages, and not gradual transition angles, such that activation and deactivation of the HOE can be achieved by a small movement of the active lens and that no or minimal transitional images are formed by the HOE during movement between the focusing powers.

As for the first optical material of the active lens, an optical material suitable for a hard lens, gas permeable lens or hydrogel lens can be used. Suitable polymeric materials for the first optical element of the active ophthalmic lens include hydrogel materials, rigid gas permeable materials and rigid materials that are known to be useful for producing ophthalmic lenses, e.g., contact lenses. Suitable hydrogel materials typically have a crosslinked hydrophilic network and hold between about 35% and about 75%, based on the total weight of the hydrogel material, of water. Examples of suitable hydrogel materials include copolymers having 2-hydroxyethyl methacrylate and one or more comonomers such as 2-hydroxy acrylate, ethyl acrylate, methyl methacrylate, vinyl pyrrolidone, N-vinyl acrylamide, hydroxypropyl methacrylate, isobutyl methacrylate, styrene, ethoxyethyl methacrylate, methoxy triethyleneglycol methacrylate, glycidyl methacrylate, diacetone acrylamide, vinyl acetate, acrylamide, hydroxytrimethylene acrylate, methoxy methyl methacrylate, acrylic acid, methacrylic acid, glyceryl ethacrylate and dimethylamino ethyl acrylate. Other suitable hydrogel materials include copolymers having methyl vinyl carbazole or dimethylamino ethyl methacrylate. Another group of suitable hydrogel materials include polymerizable materials such as modified polyvinyl alcohols, polyethyleneimines and polyvinylamines, for example, disclosed in U.S. Pat. No. 5,508,317, issued to Beat Müller and International Patent Application No. PCT/EP96/01265. Yet, another group of highly suitable hydrogel materials include silicone copolymers disclosed in International Patent Application No. PCT/EP96/01265. Suitable rigid gas permeable materials for the present invention include cross-linked siloxane polymers. The network of such polymers incorporates appropriate cross-linkers such as N,N″-dimethyl bisacrylamide, ethylene glycol diacrylate, trihydroxy propane triacrylate, pentaerythtritol tetraacrylate and other similar polyfunctional acrylates or methacrylates, or vinyl compounds, e.g., N-methylamino divinyl carbazole. Suitable rigid materials include acrylates, e.g., methacrylates, diacrylates and dimethacrylates, pyrrolidones, styrenes, amides, acrylamides, carbonates, vinyls, acrylonitriles, nitriles, sulfones and the like. Of the suitable materials, hydrogel materials are particularly suitable for the present invention.

The present multifocal optical lens can be actively and selectively controlled to provide one desired optical power at a time without or substantially without optical interference from the other optical powers of the lens, unlike conventional bifocal lenses. In addition, the programmable nature of the HOE of the active lens makes the lens highly suitable for correcting ametropic conditions that are not easily accommodated by conventional corrective optical lenses. For example, the active lens can be programmed to have corrective measures for the unequal and distorted corneal curvature of an irregular astigmatic condition by specifically designing the object and reference light configurations.

As mentioned previously, the invention may be utilized in the embodiment of an intraocular lens. In this embodiment the HOE of the lens is formed according to the methods described above. The primary difference between this embodiment and the previously discussed embodiments is that this lens is designed to be inserted into the eye. Such lenses, methods of manufacturing such lenses, and methods of inserting such lenses are generally known to those skilled in the art. These lenses and methods of manufacture are described in several publications such as U.S. Pat. No. 5,776,192 to McDonald; U.S. Pat. No. 5,044,743 to Ting; U.S. Pat. No. 4,595,070 to McDonald; and U.S. Pat. No. 4,769,035 to Kelman, all of which are incorporated herein by reference.

The invention has been described in detail, with reference to certain preferred embodiments, in order to enable the reader to practice the invention without undue experimentation. However, a person having ordinary skill in the art will readily recognize that many of the components and parameters may be varied or modified to a certain extent without departing from the scope and spirit of the invention. Furthermore, titles, headings, or the like are provided to enhance the reader's comprehension of this document, and should not be read as limiting the scope of the present invention. Accordingly, only the following claims and reasonable extensions and equivalents define the intellectual property rights to the invention.

1. An optical lens comprising at least one holographic optical element and at least one focusing element, said holographic optical element characterized by an interference fringe pattern having a finite ray acceptance angle range that diffracts up to 100% of incoming light when the Bragg condition is met, said holographic optical element further characterized as possessing substantially neutral focusing power.

2. An optical lens according to claim 1 wherein said optical lens is biocompatiable.

3. An optical lens according to claim 1 wherein said optical lens is a contact lens.

4. An optical lens according to claim 1 wherein said optical lens is a spectacle lens.

5. An optical lens according to claim 1 wherein said optical lens is an intraocular lens.

6. An optical lens according to claim 1 wherein said holographic optical lens element is a transmission volume holographic optical lens element.

7. An optical lens according to claim 1 wherein said holographic optical lens element is a reflective holographic optical lens element.

8. An optical lens comprising a first holographic optical element and a second holographic optical element, said holographic optical elements being adjacent and having non-overlapping and finite ray acceptance angle ranges that diffract up to 100% of incoming light when the Bragg condition is met, said first and second holographic elements being switchable such that when one holographic optical element is active the other is inactive.

9. An optical lens according to claim 8 further comprising a first focusing optical element situated adjacent a surface of said first holographic optical element.

10. An optical lens according to claim 8 further comprising a second focusing optical element situated adjacent a surface of said second holographic optical element.

11. An optical lens according to claim 8 wherein said optical lens is biocompatible.

12. An optical lens according to claim 8 wherein said optical lens is a contact lens.

13. An optical lens according to claim 8 wherein said optical lens is a spectacle lens.

14. An optical lens according to claim 8 wherein said optical lens is an intraocular lens.

15. An optical lens according to claim 8 wherein said holographic optical lens element is a transmission volume holographic optical lens element.

16. An optical lens according to claim 8 wherein said holographic optical lens element is a reflective holographic optical lens element.

17. An optical lens comprising a first optical component and a second optical component, said first optical component comprising a holographic optical element having a first interference fringe pattern and said second optical component comprising a holographic optical element having a second interference fringe pattern wherein said first and second interference fringe patterns are arranged such that when one interference fringe pattern is active the other is not.

18. An optical lens according to claim 17 wherein said first optical component further comprises a focusing element.

19. An optical lens according to claim 17 wherein said second optical component further comprises a focusing element.

20. An optical lens according to claim 17 wherein said optical lens is biocompatible.

21. An optical lens according to claim 17 wherein said optical lens is a contact lens.

22. An optical lens according to claim 17 wherein said optical lens is a spectacle lens.

23. An optical lens according to claim 17 wherein said optical lens is an intraocular lens.

24. An optical lens according to claim 17 wherein said holographic optical lens element is a transmission volume holographic optical lens element.

25. An optical lens according to claim 17 wherein said holographic optical lens element is a reflective holographic optical lens element.

26. A method for producing a switching holographic element which comprises the steps of:
a) providing a first source light beam;
b) splitting the first source light beam into first and second light beams, wherein one of the light beams is a reference beam;
c) providing a recordable holographic medium having oppositely located first and second surfaces, said surfaces being flat, concave or convex;
d) directing the first and second light beams to a surface of the recordable holographic medium; wherein, the first and second light beams have proper phase relationships to record a volume grating structure within the recordable holographic medium.

27. The method of claim 26 wherein the recordable holographic element comprises a crosslinkable or polymerizable optical material.

28. The method of claim 27 wherein the recordable holographic element is a fluid optical material that forms a non-fluid optical material when exposed to the first and second light beams.

29. The method of claim 28 wherein the recordable holographic element further comprises an UV absorber.

30. The method of claim 28 wherein the method further comprises the step of post curing the recorded optical element with a UV light source.

31. The method of claim 26 wherein the step of directing the first and second light beams to a surface of the recordable holographic element comprises directing the first and second light beams onto the same surface of the recordable holographic element.

32. The method of claim 26 wherein the step of directing the first and second light beams to a surface of the recordable holographic element comprises directing the first light beam onto the first surface of the recordable holographic element and directing the second light beam onto the second surface of the recordable holographic element.

33. A method for producing an optical lens comprising switching holographic elements, the method comprising the steps of:
a) providing a first source light beam;
b) splitting the first source light beam into first and second light beams;
c) providing a recordable holographic element having first and second surfaces, said first and second surfaces each having first and second portions;
d) directing the first and second light beams to the first portion of the first surface of the recordable holographic element;
e) providing a second source light beam;
f) splitting the second source light beam into third and fourth light beams;
g) directing the third and fourth light beams to the second portion of the first surface of the recordable holographic element; wherein,
the first and second light beams have proper phase relationships to record a transmission volume grating structure within the first portion of the first surface of the recordable holographic element and the third and fourth light beams have proper phase relationships to record a second transmission volume grating structure within the second portion of the first surface of the recordable holographic element.

34. The method of claim 33 wherein steps (a), (b) and (d) occur simultaneously with steps (e), (f) and (g).

35. The method of claim 33 wherein steps (a), (b) and (d) occur prior to steps (e), (f) and (g).

36. The method of claim 33 wherein the recordable holographic element comprises a crosslinkable or polymerizable optical material.

37. The method of claim 36 wherein the recordable holographic element is a fluid optical material that forms a non-fluid optical material when exposed to the first and second, and third and fourth light beams.

38. The method of claim 37 wherein the recordable holographic element further comprises an UV absorber.

39. The method of claim 33 wherein the method further comprises the step of post curing the recorded optical element with a UV light source.

40. A method for producing an optical lens comprising switching holographic elements, the method comprising the steps of:
a) providing at least one source light beam;
b) splitting the provided source light beams into first, second, third and fourth light beams;
c) providing a recordable holographic element comprising first and second portions;
d) directing the first and second light beams to the first portion of the recordable holographic element;
e) directing the third and fourth light beams to the second portion of the recordable holographic element; wherein
the first and second light beams have proper phase relationships to record a reflection grating structure within the first portion of the recordable holographic element and the third and fourth light beams have proper phase relationships to record a second reflection grating structure within the second portion of the recordable holographic element.

41. The method of claim 40 wherein the recordable holographic element comprises a crosslinkable or polymerizable optical material.

42. The method of claim 41 wherein the recordable holographic element is a fluid optical material that forms a non-fluid optical material when exposed to the light beams.

43. The method of claim 42 wherein the recordable holographic element further comprises an UV absorber.

44. The method of claim 40 wherein the method further comprises the step of post curing the recorded optical element with a UV light source.

45. A method for producing a composite optical lens comprising at least one holographic optical lens element, the method comprising the steps of:
a) providing a first polymerizable or crosslinkable fluid optical material in a first mold;
b) recording a grating structure in the first fluid optical material, thereby forming a non-fluid holographic optical lens element;
c) providing a second mold, the second mold having a cavity volume larger than the non-fluid holographic optical lens element;
d) providing a second polymerizable or crosslinkable fluid optical material and the non-fluid holographic optical lens element in the second mold; and
e) polymerizing or crosslinking the second polymerizable or crosslinkable fluid optical material in the second mold.

46. The method of claim 45 wherein the first and second fluid optical materials are the same fluid optical material.

47. The method of claim 45 wherein the first and second fluid optical materials are chemically compatible materials.
